(19) United States
(12) Patent Application Publication
(10) Pub. No.: US 2006/0217199 A1
(43) Pub. Date: Sep. 28, 2006

(54) Real-time gaming or activity system and methods

(75) Inventors: Thomas A. Adcox, Nevada, TX (US); Joe A. Rutherford, Fate, TX (US)

Correspondence Address: DOCKET CLERK, P.O. DRAWER 800889, DALLAS, TX, 75380, US

(73) Assignee: CVC Global Provider, L.P., Fate, TX (US)

(21) Appl. No.: 11/364,910

(22) Filed: Mar. 1, 2006

Related U.S. Application Data
(60) Provisional application No. 60/657,818, filed on Mar. 2, 2005.

(51) Int. Cl. A63F 13/00

(52) U.S. Cl. 463/40

(57) ABSTRACT

An on-line gaming or other activity system utilizing videoconferencing or other communication methods in a broadband network provides remote locations (participants or spectators) with live video/audio of the on-going game or activity occurring at a different location. A network device, such as a videoconferencing unit, at the remote location receives video that includes real-time or live images of actual physical object(s) as presented or utilized during the game or activity (at the other location). The remote participant device is operable for receiving real-time or live video/audio or other user input (at the remote location) and transmitting this information to the game or activity location. This user input information received by the game or activity is operable for controlling, affecting or playing the game/activity at the game/activity location.

### CROSS REFERENCE TO RELATED APPLICATION(S)

This application claims priority under 35 USC 119(e) to U.S. Provisional Application Ser. No. 60/657,818, filed on Mar. 2, 2005, and which is incorporated herein by reference.

### TECHNICAL FIELD OF THE INVENTION

The present invention relates to telecommunications systems and methods, and in particular, to a real-time gaming and activity system using videoconferencing methods for communications between one or more remote participants in an interactive activity.

### BACKGROUND

Telecommunications networks (e.g., the Internet) have provided the opportunity for more and more individuals to connect to a network remotely, and further provide the ability for communications between different locations in the traditional audio/video conferencing manner, such as for a business meeting.

The Internet has also provided the basic infrastructure to allow remote users to play games or engage in activities online via one or more computers/servers which produce and utilize computer generated video displays transmitted to the participant(s). Thus, these games or activities are actually computer generated and/or computer operated (i.e., the game is played or controlled by the computer). Further, there have been no facilitation methods, systems or applications which allow remote participants the ability to participate in an actual activity occurring at a different location and to provide input that affects a physical object of that activity.

Accordingly, there is a need for a real-time gaming and activity system that allows a remote user to participate in an activity occurring at a different location on a real-time, real-sensory basis, and with real input that affects a physical object of the activity.

### SUMMARY

In accordance with one aspect of the present invention there is provided an interactive on-line gaming method. The method includes generating a first real-time video signal of a first physical object in an on-going game occurring at a first location, transmitting the first video signal to a first remote participant at a second location, and receiving input from the first remote participant, the input operable for interacting with the on-going game.

In accordance with another embodiment, there is provided an on-line interactive card gaming method. The method includes dealing, at a first location, one or more playing cards associated to a first participant by placing the one or more cards within a first participant viewing area and generating a first video signal comprising an image of the first participant viewing area thereby generating an image of the one or more playing cards placed therein, and the first video signal is transmitted to a first remote participant at a second location. The method further includes dealing, at the first location, one or more playing cards associated to a second participant by placing the one or more cards within a second participant viewing area and generating a second video signal comprising an image of the second participant viewing area thereby generating an image of the one or more playing cards placed therein, and the second video signal is transmitted to a one of the first remote participant and a second remote participant at a second location. The method further includes receiving, at the first location, input from the first remote participant, the input operable for affecting the on-going game.

In yet another embodiment, there is provided a gaming system having a gaming table residing at a first location, the gaming table having a plurality of predefined areas on the table. A plurality of cameras corresponding to the plurality of predefined areas, each of the plurality of cameras operable for viewing the respective predefined areas and generating a video signal comprising an image of an object placed within the predefined area. The gaming system further includes means for transmitting the plurality of video signals generated by the plurality of cameras over a network to one or more players geographically remote from the first location and means for receiving input from the one or more remote players.

In another embodiment, there is provided a gaming table located at a first location and operable for use with a predetermined game utilizing one or more die. The table includes a surface for receiving the one or more die and an electro-mechanical means for rolling the one or more die onto the surface in response to a control input received from a remote player device via a communications network.

In still another embodiment, there is provided a method of operating a slot machine located at a first location. The method includes transmitting a live real-time video signal of a display generated by the slot machine, receiving a control signal via a network from a remote player terminal located at a second location, and operating the slot machine in response to the received control signal.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 is an overall block diagram of a gaming system in accordance with the present invention; and

FIG. 2 is a more detailed diagram of the player remote terminals shown in FIG. 1;

FIG. 3 is a more detailed diagram of the player associated local terminals and dealer terminals shown in FIG. 1;

FIG. 4 is a diagram illustrating the flow of video/audio signals between and among various terminals and the bridge/gatekeeper.

FIGS. 5A, 5B, 5C, 5D are examples of exemplary displays for two different player remote terminals and the two dealer terminals, respectively;

FIG. 6 is an overall diagram illustrating a slot machine gaming system 600 in accordance with the present invention.

FIG. 7A is a block diagram of a prior art slot machine;

FIG. 7B is a block diagram of a slot machine shown in FIG. 6 in accord with the present invention;

FIG. 8 is an example of an menu/sub-menu system for navigating the gaming entity;

FIG. 9 is an overall diagram illustrating a live on-line auction system in accordance with the present invention;

FIGS. 10A and 10B are top and side views of a game or activity table or platform in accordance with the present invention;

FIG. 11 is a diagram illustrating another embodiment of a game or activity table or platform; and

FIG. 12 is another embodiment of a gaming system in accordance with the present invention.

### DETAILED DESCRIPTION OF THE INVENTION

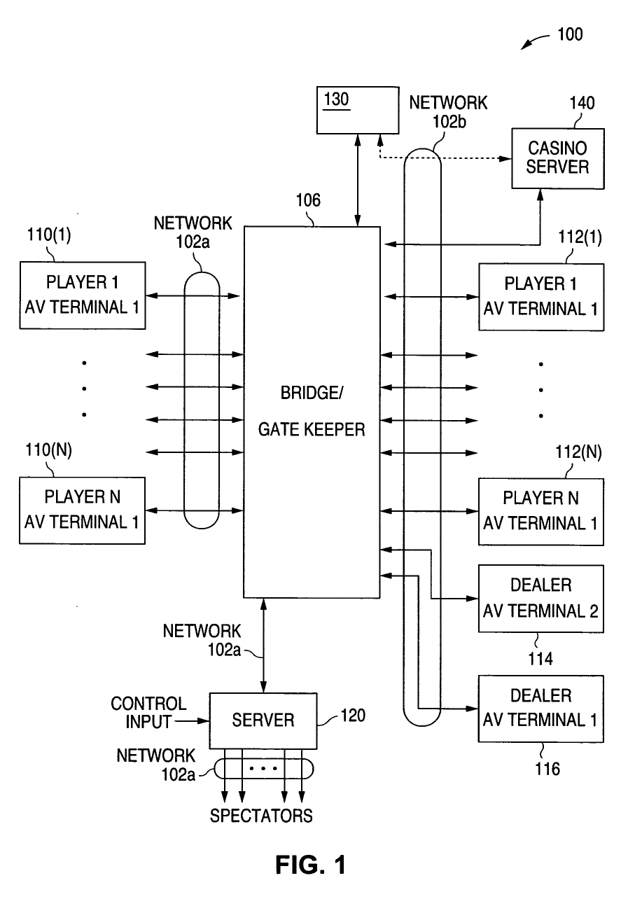

Referring to FIG. 1, there is shown one embodiment of a gaming system 100 in accordance with the present invention. The gaming system 100 includes a communications network 102a and a communications network 102b. In one embodiment, though appearing as separate networks in the FIG. 1, the network 102a and 102b are part of an overall telecommunications network 102, such as a broadband network 102 (a wide area network or WAN). The network 102 may function in accordance with any modes or communications protocols (e.g., ATM, frame relay, TCP/IP, H.323, SIP, or other protocols, and even PSTN) and may be wired or wireless (including optical). The network 102 may also be comprised a combination of networks that are communicatively coupled. In another embodiment, the network 102b may be a local area network (LAN) with the network 102a being part of a WAN. A bridge or gatekeeper 106 is communicatively coupled to a plurality of network terminals or devices 110(1) thru 110(N), 112(1) thru 112(N), 114 and 116 (or nodes). Each of these devices may be referred to herein using the terms “terminal”, “device”, “node”, “video conferencing unit” or “VCU”.

Conceptually, the terminals 110 are characterized as the “off-site” or “remote” component of the game or table (or activity), while the terminals 112, 114, 116 are characterized as the “on-site” or “local” component of the game or table (or activity).

Each of the terminals 110 is geographically separated (e.g., in different room, different facility/building, different city, different state, or even a different country) from the location of the terminals 112, 114, 116 (i.e, the game or table). Thus, each remote terminal 110 resides at the remote player's physical location. Further, each of the terminals 110 may be geographically separate with respect to each other or located within a centralized remote facility, or configured in some combination thereof (e.g., one terminal at a first facility, a second terminal at a second facility, and third and fourth terminals at a third facility). In another embodiment (not shown), some players may be physically present at the table (local player), while other players are at a remote location (remote player).

As will be appreciated, alternatively, the geographical separation of the remote terminals 110 from the terminals 112, 114, 116 may be characterized in that the remote terminals 110 are positioned at a remote player's location (i.e., a player associated with the specific remote terminal 110) which is physically separate from the table or game (i.e., terminals 112, 114, 116) such that the player is not physically present at the game/table or cannot physically interact with the game/table, unlike conventional gaming, during a live game/activity. In other words, the players are present at one or more locations that are different from the location of the physical instruments of the activity (such as the dealer, table/game or other physical items associated with the activity). As a specific example in accordance with the present invention, in a game of Texas Hold'Em poker, one or more players are present at one or more locations other than the location of the dealer and the physical cards that are being dealt (i.e., at the game/table).

Each of the local terminals 112, 114, 116 is usually located or resides within the same facility which is different from the location of the remote terminals 110 (remote players). In a different embodiment, some components of the terminals 112, 114, 116 (to be described below) may be positioned at the game or table, while some other components or functionality may be positioned in close proximity therewith, with the device overall functionality located within the same “facility” or “logical” facility. As described, such game or table (or activity) facility is geographically separate from the remote terminals 110.

The bridge/gatekeeper 106 may physically reside at any location. In one embodiment, the functionality of the bridge/gatekeeper 106 may be provided by a telecommunications carrier or service provider and include gatekeeping (one-to-one) and conferencing (one-to-many, many-to-one, or many-to-many connections) functions, and other switching functions. In another embodiment, the bridge/gatekeeper 106 may reside at or near the facility hosting the game/table, and form part of a LAN including the terminals 112, 114, 116 and may further interface to the broadband network 102a. Such configuration may beneficially provide enhanced security when the network 102b, terminals 112, 114, 116 and the bridge/gatekeeper 106 form part of a local area network under the control of a single entity or required to be regulated by a governmental unit or agency. In this embodiment, the bridge/gatekeeper 106 interfaces with the broadband network 102a (or through some other interface device, not shown) to communicate with the remote terminals 110. Moreover, the use of the term “bridge/gatekeeper” is not intended in any way to limit this functionality as being provided by a specific device. Such functionality may be provided by any device, regardless of the nomenclature, such as a server, switch, router, network processor, etc.

An exemplary device or unit (or service) that may be utilized to provide the functionality of some or all of the bridge/gatekeeper 106 is available from TEVUE or Tech Dynamics. In the event that such available bridge/gatekeepers 106 may not provide all the functionality described herein, a person of ordinary skill in the art would be able to modify such units to provide the desired functionality consistent with the methods and functions described herein. Moreover, while the bridge/gatekeeper 106 may be shown as a single device, multiple devices in one or more locations may be utilized, and the functionality may be centralized or distributed within the network.

In the embodiment shown, the gaming system 100 includes a plurality of participants. The term “participant” or “player” can refer to a player, dealer, or other interacting entity providing input or other interaction with the game or activity. One example of such interacting entity may include a financial institution, account or bank 130 (physical or electronic) providing debiting, crediting, authorization and transfer of electronic funds, account setup and authorization, etc. The account 130 may be operatively connected and communicate with the player terminals 110 and the dealer terminal(s) 112, 114 and a table/game controller or processor 312 (not shown on FIG. 1) through the network.

A server 120 may be communicatively coupled to the bridge/gatekeeper 106 via a network (network 102 or a different network). The bridge/gatekeeper transmits video/audio signals (as described further below) to the server 130. This server 120 (e.g., a data/web server) functions to receive the AV signals and deliver (e.g., streaming) via a network (such as the Internet) to a plurality of spectators (audience) at various remote locations. This provides the ability of non-participants to view the game as it is being played in real-time, or on a delayed basis. The non-participants may, for example, log onto a particular website page (via internet, TCP/IP) or connect via some other communication protocol (e.g., such as H.323 or SIP) with the server 120 and receive actual or modified views of the on-going game. The AV signals (displays, screen shots, audio) available to the public may be chosen as desired, and may include one or more of the following: audio of the players/dealer/game; video of the players' hand/dealer's hand/table or game; video of the players/dealer; or some other AV signal. In addition, advertisements, messages or other video/audio may be added to the transmission by the game/activity organizer or host or other authorized entity.

For security reasons, in one embodiment, the broadcast of the game to the non-participant(s) will be delayed. The amount of delay may be chosen as desired to take into consideration various factors, including the amount of acceptable delay, the security desired, and the type of game. The amount of the delay may be either fixed or variable, and may be triggered by an event, such as the end of that hand of play or by dealer input. Other triggers may be used. A control input to the server 120 controls the transmission and delay functions, and games may be further re-broadcast at later times.

In the system 100 shown in FIG. 1, each player participant 1 thru N is associated with the off-site remote terminal 110(1 thru N) and the on-site local terminal 112(1 thru N), respectively. The acronym “AV” refers to audio/visual, and the terminals may have audio, video or both capabilities, as desired. The dealer participant is associated with the on-site local terminal 114 and the on-site local terminal 116. In other configurations, there may exist only a single on-site local terminal and/or a single on-site dealer terminal, depending on the activity functionality desired.

A server 140 is shown connected to the network 102. The server 140 may operably provide an entry point into the gaming system for the players. For example, the player may call a main communications address and connect to the server 140 for logon and user id and password authentication. The server 140 may then interface with the account 130 to transfer/authenticate player funds for use in the system (i.e., “buy” gambling chips). The server proceeds to transmit gaming choices to the player, and upon selection, the call is switched for control by the selected game/table and the server 140 transfers account information (financial account information) for use by the selected game/table during the game/activity.

With continued reference to FIG. 1, the general operation of an example activity in which there are eight player participants and one dealer participant (with two terminals), will now be described. Each of the player participants (via its respective remote terminal 110) communicatively connects to the bridge/gatekeeper 106 and establishes a communications link therewith. Each player remote terminal 110 transmits real-time video of the player (e.g., actual image of player) to the bridge/gatekeeper 106. In addition, the associated player local terminal 112 transmits real-time video of the player's playing area (playing area) to the bridge/gatekeeper 106, which transmits or forwards the real-time video of that player's playing area to the player (remote terminal 110). The dealer local terminal 114 transmits real-time video images of the dealer (dealer image or overall table view) to the bridge/gatekeeper 106. The associated dealer local terminal 112 transmits real-time video of the dealer's playing area (dealer play) to the bridge/gatekeeper 106, which transmits or forwards the real-time video of the dealer playing area to each player (remote terminals 110). In addition to the video, each player remote terminal 110, the local terminals 112 and the dealer terminals 114, 116 may also provide an audio signal for audio for that terminal, as well as any control or command signals.

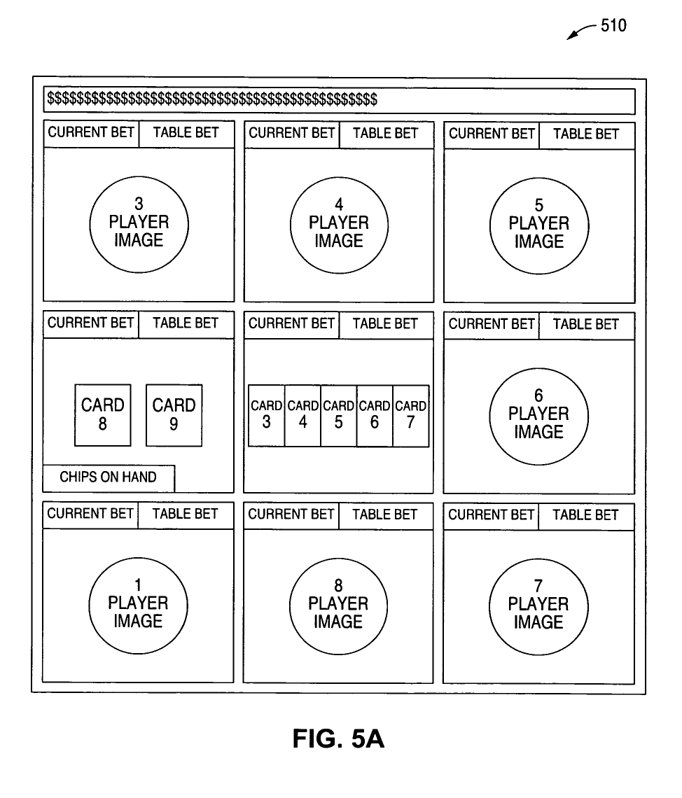

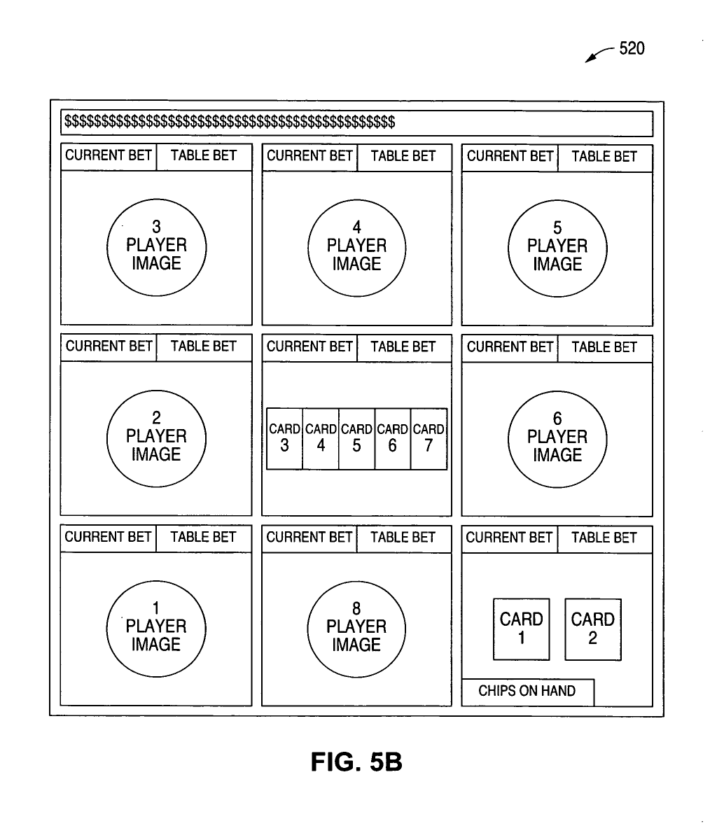

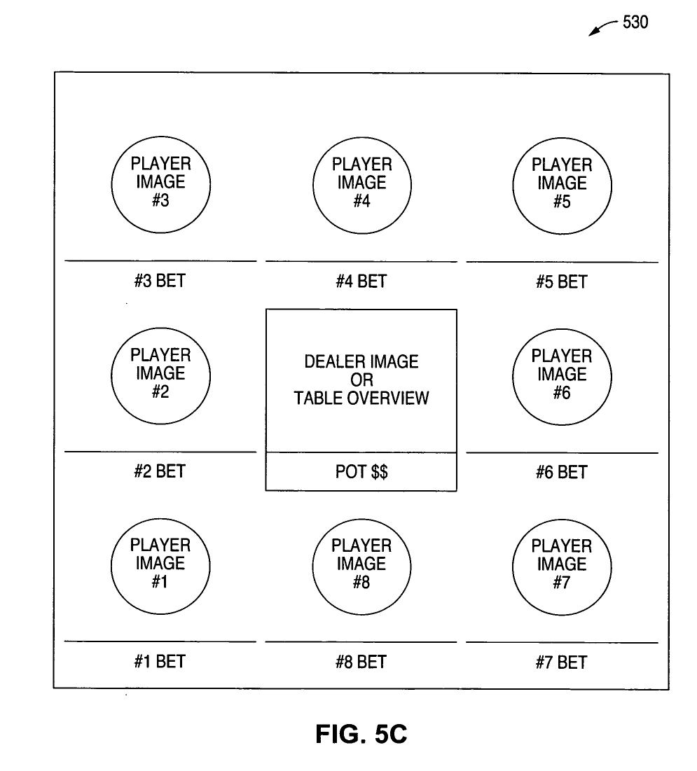

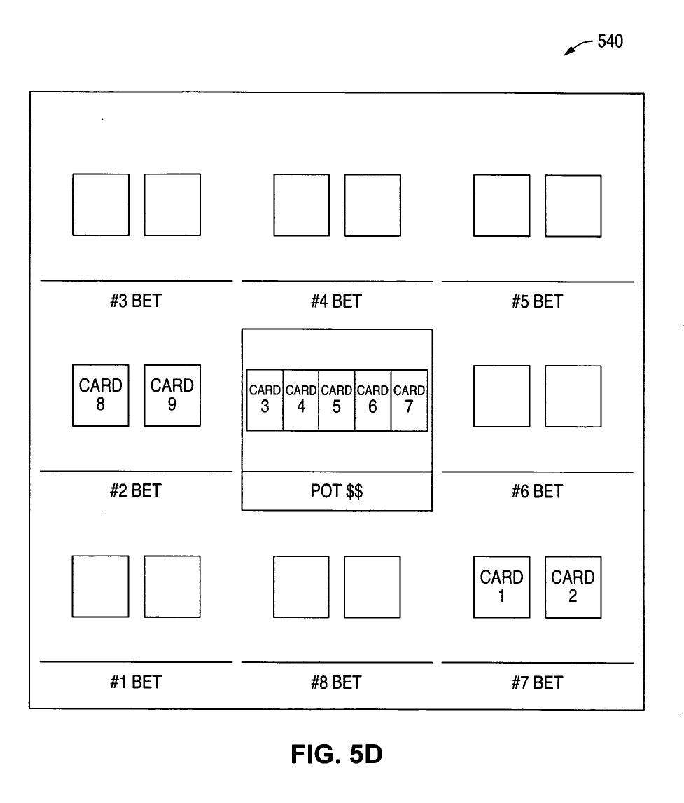

In one embodiment, the bridge/gatekeeper 106 generates ten separate real-time composite video streams from the received real-time video streams. Eight composite video streams are transmitted—with each respective one of the eight streams being transmitted to a respective one of the eight players (video from the remote terminals 110)—one for each player. Each respective player's composite video input stream is generated by the combination of each of the other seven players real-time video (video from their remote terminals 110) and the real-time video of that respective player's playing area (video from the respective player's local terminal 112) and the real-time video of at least one of the dealer terminals 114, 116. Now referring to FIGS. 5A and 5B, there are shown renderings of the composite video image 510 displayed to player #2 (FIG. 5A) and the composite video image 520 displayed to player #7 (FIG. 5B).

Another composite video stream is transmitted to the dealer (terminal 114) and combines each of the eight players images (video from remote terminals 110) and the dealer image (video from dealer terminal 116). Now referring to FIG. 5C, there is shown a rendering of the composite video image 530 received and displayed at the dealer terminal 114 (FIG. 5C). Yet another composite video stream is transmitted to the dealer (local terminal 116) and combines each of the eight players playing area (video from local terminals 112) and the dealer playing area (video from local terminal 114). Now referring to FIG. 5D, there is shown a rendering of the composite video image 540 received and displayed at the dealer terminal 116 (FIG. 5D). It will be understood that the composite video signals each received at the respective terminals 114, 116, as described above, could be received by the other respective terminal 114, 116, as well, or different combinations may be used. As will be appreciated, the composite video signal that generates image 540 is optional when the dealer has the ability to view all the players cards and the dealer hand while present at the table and/or for other reasons.

Audio signals from the terminals 110, 112, 114, 116 may be combined by various means and methods and transmitted by the bridge/gatekeeper 106 along with the composite video signals (as audio/visual conference signals), though it appears logical to combine audio from the eight remote player terminals 110 with the audio from the dealer terminals 114, 116 (dealer and table audio) and transmit the composite audio (conference audio) with each of the ten composite video signals. In one embodiment, the bridge/gatekeeper 106 may include audio CODECS and audio compression and combining functionality to generate a single composite audio signal (in a desired format) from multiple audio signals. A table/game controller 312 provides routing/switching matrix information to the bridge/gatekeeper 106 to achieve the desired mapping of the input/output ports and combination of video sources to generate composite video. This routing information is updated when needed, such as when players join or leave the game. This functionality may reside in the table/game controller 312 or any other device.

As will be appreciated, any number of player participants may be involved in an activity, and the content and format of the composite video (and audio) signals (and image displayed) will depend thereon. Moreover, the positioning, size, and other image features of the player participants and dealer in the composite images may be modified or chosen as desired, and may be the same or different for each player. Such configuration(s) may further be player participant or user defined or determined.

The player associated local terminals 112 function to capture real-time or live video images of a respective, defined “playing area”. In other words, one or more physical, spatial playing areas are provided within the local or on-site component of the gaming system 110. This may include a specific area that is monitored by the camera or other video capturing device. The size, shape and focus of the playing area may be determined as desired, depending on the functionality and activity.

The present invention provides a method of remote or on-line participation by remote players (or participants) of an activity (such as a game) that is situated or residing at one specific facility or location, while the remote players are situated at another geographically distant location or facility. The physical activities or actions within the game are performed at the local or on-site location, and these activities are monitored by the participants at different location(s) by receiving real-time video (and audio) streams originating at the local or activity location. In other words, the remote players “see” or view the game as it is being played in order to participate in the live game/activity.

For example, in a game of poker operated in accordance with the present invention, the poker “table”, dealer, and playing cards physically reside at the local or on-site location, while the players physically reside at one or more remote or off-site locations. The activities at the local or on-site location are monitored and transmitted via video (and audio) stream(s) to the remote participants. A remote participant interacts with the game (viewing dealt cards and/or dealer hand, betting, discarding, instructions to cause a physical operation at the local or on-site location, etc.) by providing instructions or input (e.g., electronic commands, audio, or physical movements captured by video) to the local or on-site location via wire or wireless communications network. In a Texas Hold'Em poker game, the dealer and players would begin the poker game by electronically (audio, video, command message) delivering an ante (and initial bet, if necessary) to the poker pot, similar to the conventional method, but with the participants not physically present and providing interaction via telecommunications.

Next, the dealer would begin dealing the hand, in the traditional way, and from a traditional deck of playing cards, giving two cards to each player by placing the dealt cards within the player's playing/viewing area (on the poker “table”). The dealer's or common/shared hand (five cards, not able to be viewed at this time) would be dealt in a similar manner. Each player playing/viewing area is continuously monitored and separately captured using real-time video (and may possibly include capturing audio in close proximity also). The local or on-site location transmits video of each player's playing/viewing area to the respective player, and also transmits video of the dealer playing/viewing area to each player. Each player receives video of its associated playing/viewing area, and would not receive video of the other players' playing/viewing areas.

The dealer and players interact via the communications means to complete a round of betting. Next, the dealer would “turn over” three of the five cards within the dealer playing/viewing area and the video of the dealer playing/viewing area would show this (as it is being transmitted “live” to the players). The dealer and players would interact again via the communication means, and the poker hand/game would continue, until ultimately concluded in the traditional sense.

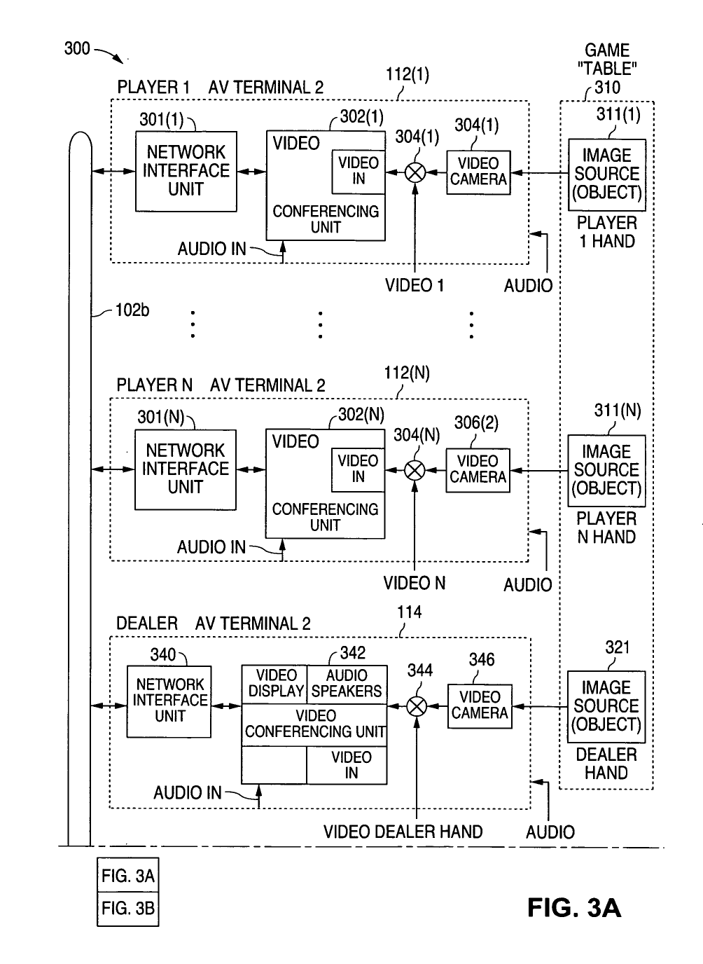

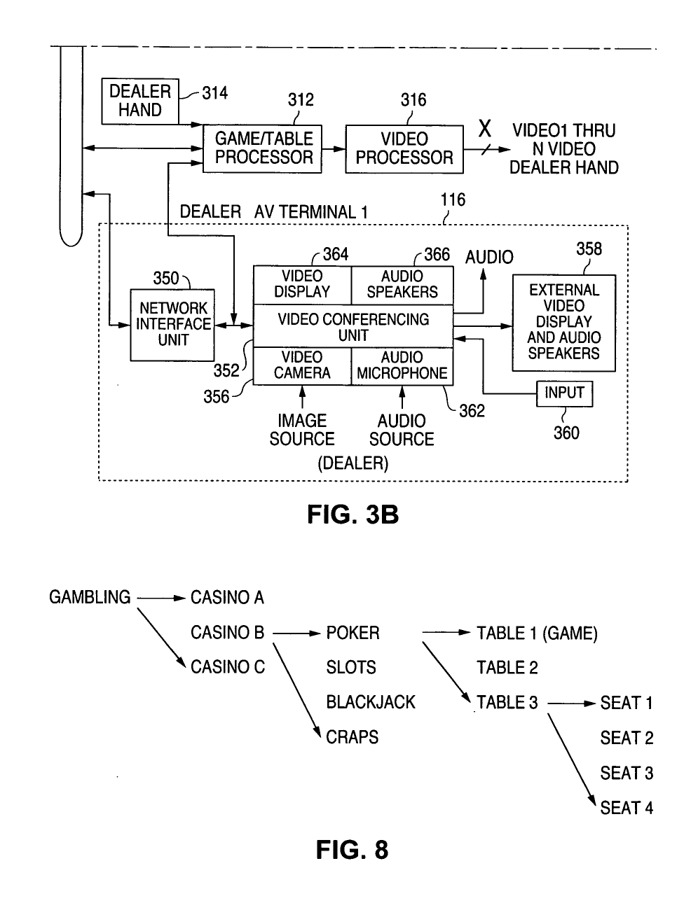

In one embodiment, the remote players' input that provides the player's instructions/interaction is transmitted to the dealer/game by audio (and possibly video). In this method, the remote player would provide instructions (e.g., bet amount, ante amount, fold hand, request another card, etc.) in the form of audio. The dealer would then manually input this information (via a dealer input device, such as element 314 in FIG. 3 or other input means for one of the dealer terminals 114, 116) to the table/game controller 314 and this remote player's instructions/actions are then processed. In further embodiments, the dealer may host or control the game/activity by moving or adjusting physical components (e.g., moving physical chips into the pot) of the game in response to instructions and/or other input from the player, and further communicating via audio/video with all the players, thus communicating movements/play to the players.

In yet another embodiment, the remote players' input may be received in electronic form (e.g., control/data signals). In this method, the remote player would provide instructions/commands via user input in the form of keystrokes, buttons, mouse clicks etc.), which are translated to control signals sent via the network to the table/game controller and processed.

As will be appreciated, the present invention provides “live” activities, as in the traditional sense, but with the players remotely located and telecommunicatively coupled to the “live” component of the activity taking place at the local or on-site location. One or more live or real-time video (and audio) streams or feeds of any one or more instruments of the activity are sent to the remote players. The players then interact electronically (via a communication path or message that may include video, audio, commands, or combinations thereof).

It will be understood that the term “real-time” or “live” video also refers to video of an actual object as that object physically presents at the object location or point of origin of the object, and may include video contemporaneously transmitted at substantially the same time as the video is generated, as well as delayed video signals (though video of a “live” object or component part of an on-going or live game or activity). In addition, the video/audio signals may be delayed for a short period of time due to transmission medium delays or inherent delays in the communication system. Thus, the video that is transmitted to each remote player is a video image of an object (e.g., the physical cards from a traditional playing deck of cards) that resides or is present at another location during an on-going or “live” game or activity, and may further include audio.

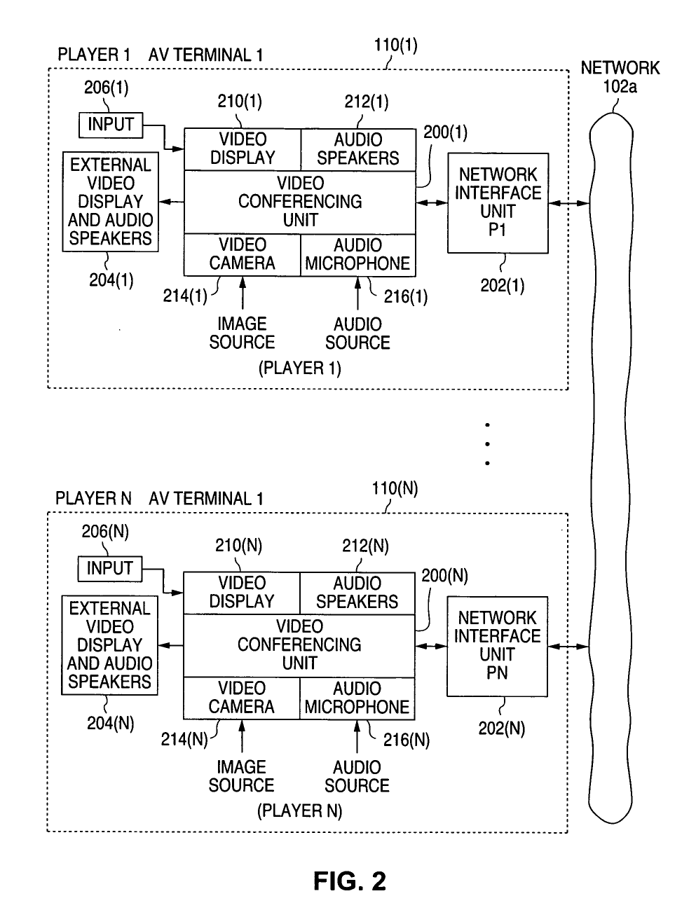

Now referring to FIG. 2, there is shown a more detailed diagram illustrating the player remote terminals 110(1) thru 110(N). The player remote terminal 102 includes a video conferencing unit (VCU) 200 and a network interface unit 202. The network interface unit 202 interfaces and connects the VCU 200 to the network 102m and may include a cable modem, digital subscriber line (DSL) modem, or other device providing network interfacing to a broadband network or other data network, including networks utilizing Voice over Internet Protocol (VoIP).

The video conferencing unit (VCU) 200 is shown including a video output display 210, one or more audio output speakers 212, a video camera 214, and audio microphone 216. The VCU 200 may also include an external input device 206 (such as a mouse, keyboard, or other input device connected to (or integrally constructed with)) the VCU 200. Optionally, the VCU 200 may include input means (not shown) integrally included with the VCU (such as softkey buttons, keyboard, etc.) for providing user input to the VCU 200. The video display 210 displays images generated from video signals received via the network 102, while the audio speaker(s) 212 provide audio output for similarly received audio signals. The video camera 214 and audio microphone function to capture images and audio and generate electronic video and audio signals for input to the network 102. The VCU 200 includes circuitry and functionality to provide video and audio processing, network interfacing (local network), videoconferencing and IP communications processing in accordance with various protocols (such as H.323 and Session Initiated Protocol (SIP)), network processing and compatibility (e.g, TCP/IP, HTTP, DNS SRV, TFTP, etc.), and in one particular embodiment, utilizing Voice (or Video) over IP (VoIP). An exemplary VCU that may be utilized in the present invention are devices available from Viseon, Inc. (sold under the mark VisiFone, i.e., a digital home telephone) or TATUNG. Other devices having similar, less or more functionality or components may be utilized.

In one embodiment, the VCU 200 further includes audio/video output connections for outputting audio/video to an external display and audio speaker device 206. This may be utilized where the user desires to project video (and audio) and a system separate from the built-in display 210 and speaker(s) 212. In addition, the VCU device 200 may not include one or more devices such as the display 210, speakers 212, camera 214 and microphone 216. In such embodiments, it may be possible to utilize external devices for such functions provided appropriate input connections (audio/video) are provided by the VCU 200.

It will be appreciated that the VCU 200 (with or without the external devices 204 and input device 206, and with or without all the I/O) is considered a stand-alone video conferencing unit—and may be plugged and played by connection to the broadband network 102. Further, the network interface device 202 may or may not be incorporated within the stand-alone video conferencing unit 200.

In basic operation, the VCU 200 captures real-time source audio and visual (at the location of the VCU 200) and transmits the AV signals via the network 102 to the bridge/gatekeeper 106. The VCU also receives audio and video signals from the bridge/gatekeeper 106 via the network 102 for rendering by the VCU 200 and output through a display and audio speakers. In one embodiment, the audio/video signals transmitted and received by the VCU 200 (over the network 102) are in accordance with any VoIP or videoconferencing protocol (for example, SIP, H.323, etc.) and in another specific embodiment, the signals are in accordance with the H.323 protocol standard.

Now referring to FIG. 3, there is shown a detailed diagram of one embodiment of the present invention including the components (located at the game/table or local facility) of the game or activity 300. These include the player associated local terminals 112, the dealer terminals 114, 116, a table device 310, a betting processor or computer 312, a game or dealer control input device 314 and a video processor 316.

The player associated local terminals 112 are shown logically as including a network interface device 301, and videoconference unit (VCU) 302, a video combiner or overlay unit 304, and a video camera 306. The network interface device 301 and the VCU 302 are similar to the network interface devices 202 and VCUs 200, respectively, while the video camera 306 is similar to the video cameras 214, as all described above. In operation, for a particular player (1 thru N), a video image of a specific remote player's playing area 311 is captured by the camera 306. In other words, for any object(s) placed within or on the playing area 311, a video signal incorporating the image of the object(s) is generated by the camera 306 and input to the respective VCU 302. The proper video format is then generated and the video signal is transmitted to the network 102 via the network interface device 301. This operation is similarly performed for each of the player associated remote terminals 112 and their respective playing/viewing areas 311.

The dealer local terminal 114 is shown logically as including a network interface device 340, a videoconference unit (VCU) 342, a video combiner or overlay unit 344, and a video camera 346. The network interface device 340 and the VCU 342 are similar to the network interface devices 202 and VCUs 200, respectively, while the video camera 346 is similar to the video cameras 306, as described above. In operation, for the dealer, a video image of the dealer's or game playing area 321 is captured by the camera 346. Any object(s) placed within or on the playing area 331, a video signal incorporating the image of the object(s) is generated by the camera 346 and input to the respective VCU 342. The proper video format is then generated and the video signal is transmitted to the network 102 via the network interface device 340.

As will be appreciated, the video cameras 306, 346 may each be considered to be part of (either integral with or physically separate but logically part of) the respective VCUs 302, 342. In the embodiment shown, the video signal output from the respective camera 306, 346 is input to a respective video combiner unit 304, 344 which combines the object(s) image video signal with an image overlay to generate a combined video signal. The combined video signal includes an image overlaid on top of the video image of the object(s) within the player viewing area 311, 321. The composite video image is then transmitted across the network 102 for viewing by the remote player at the remote location (as described previously, the remote player would receive video of the dealer's playing area and video only of that player's playing/viewing area, and not the other players' viewing/playing area).

The overlay image generally includes player-specific information relating to the game or activity, and may further include other information not specific to the player. Examples include player chip count, current bet, table pot, table bet, etc. Such player-specific information is generated by the dealer or the game/table processor or controller 312 in response to dealer input or input from the player (via the network 102). See also, FIGS. 5A thru 5D.

In another embodiment (not shown), each respective camera 306, 346 may be integrated with the respective VCU 302, 342 and output the video signal to the respective video combiner unit 304, 344 (for further processing) with the output thereof input back into the respective VCU 302, 342 for transmission across the network 102.

The dealer local terminal 116 is shown logically as including a network interface device 350 and a videoconference unit (VCU) 352. The network interface device 350 and the VCU 352 are similar to the network interface devices 202 and VCUs 200, respectively, while the video camera 346 is similar to the video cameras 356, as described above. In operation, for the dealer, a video image of the dealer or overall game playing area 321 is captured by the camera 356. The functionality, operation and optional components (including input device 360, external display and audio device 358, microphone 362, video display 364 and audio speakers 366) of the dealer terminal 116 are similar to the player remote terminals 110 (accordingly, a detailed description is not provided of these components of the terminal 116). The proper video format is then generated and the video signal of the dealer or overall activity area is transmitted to the network 102 via the network interface device 350.

As will be appreciated, the player associated local terminals 112 and dealer terminals 114, 116 are shown with dotted lines including specific components or functionality therein. However, this description is only for illustrative purposes, and the terminals may include fewer or additional components/functionality as shown. The components or functionality of the terminals could be combined into one or more different units not considered “within” or part of the terminal. For example, the video combiner units 304, 344 of the terminals 112, 114 could be combined into a single physical unit along with the video processor unit 316, whereby the unit would receive N+1 video inputs (from the cameras 311 and 321), receive input from the betting processor 312, and generate and output the plurality of composite video signals for input to the respective VCU 304, 344 of the terminals 112, 114.

As will be appreciated, audio associated with each of the player associated local terminal 112 and the dealer terminals 114, 116 may also be input to the respective VCUs 304, 342, 352 (for that associated terminal) and transmitted to the bridge/gatekeeper 106. As mentioned previously, it may be more efficient to output only audio signals from one or two audio sources (the dealer terminals 114, 116) from the game/activity 300, however each terminal could transmit its own audio.

In the embodiment shown, ten separate video signals (optionally including overlay images) are transmitted to the bridge/gatekeeper 106 via the network 102. In another embodiment, any number of the video signals could be combined into a composite video signal (i.e., multiscreen) or time-division multiplexed composite video signal (each camera consecutively sampled during a predetermined time frame) and transmitted to the bridge/gatekeeper 106. In such embodiment, the bridge/gatekeeper 106 may be provided with additional information or functionality to allow it to properly separate the appropriate video images and send to each to the correct player remote terminals 110.

In the embodiment shown and described in FIGS. 1 and 3, each of the terminal devices 110, 112, 114, 116, the bridge/gatekeeper 106 and the bank 130 are all devices coupled to a WAN-type network 102. As such, each of these devices is independently addressable via the network. In one embodiment, these devices may physically reside anywhere. In another embodiment, the player and dealer terminals 110, 112, 114, 116 reside anywhere, while the bridge/gatekeeper 106 and bank 130 reside outside the United States. In yet another embodiment, the player remote terminals 110 reside anywhere, the player local and dealer terminals 112, 114, 116 reside within one state in the United States, while the bridge/gatekeeper and bank 130 reside outside the United States. In still another embodiment, the player remote terminals 110 reside anywhere, and the player local and dealer terminals 112, 114, 116 and the bridge/gatekeeper and bank 130 reside within one state in the United States.

As will be appreciated, the remote player operably receives real-time (or live) video/audio from the game or game table (i.e., casino) and participates contemporaneously, and provides input or interaction that is live or real-time (video or audio) from the remote player.

In another embodiment (not shown), the player remote and dealer terminals 112, 114, 116 and the bridge/gatekeeper 106 are part of a local area network 102b, and may even reside within a single facility. In this embodiment, a router or switch or other interface point may couple the bride/gatekeeper 106 to the network 102b.

Still referring to FIG. 3, the game/table processor 312 is operable to receive input data from a dealer input device 314 and/or input data from each of the player remote terminals 110 (either directly or via the dealer terminal 116 from that terminal's network interface device 350). The processor 312 functions to manage and control various aspects and parameters of the game, including table limits, controlling game pots, transferring pot to winning player, controlling display of each player's bets and chips, receiving input commands from the remote players or dealer, output betting or other information to the video processor 316 to allow for the generation of overlay images to be placed upon the respective images of the players' viewing/playing areas, receiving financial/game account information to handle betting/debiting/crediting the players' accounts. etc.

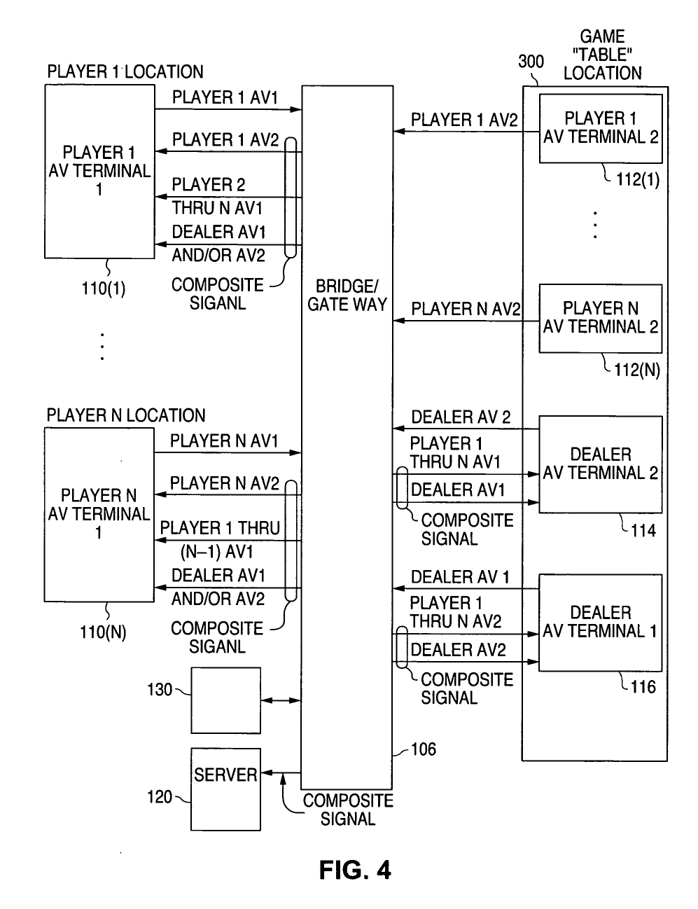

Now referring to FIG. 4, there is shown a diagram illustrating the flow of video/audio signals between and among the terminals 110, 112, 114, 116 and the bridge/gatekeeper 106. Remote player terminal 110(1) generates and transmits video/audio of the remote player (1) to the bridge/gatekeeper 106 (upstream channel). The player remote terminal 110(1) receives video/audio signals (in one embodiment, composite signals) from the bridge/gatekeeper 106 (downstream channel). The composite signal includes (1) video/audio from the player associated local terminal 112(1), (2) video/audio from each of the other remote player terminals 110 (2 thru N), and (3) one or both of the video/audio from the dealer terminals 114, 116. Similarly, the other player remote terminals (2 thru N) generate, transmit and receive similar video/audio, as shown.

The player associated local terminal 112(1) generates and transmits a video image of the player viewing/playing area 311(1), and any object(s) placed with this area, and optionally additional activity information, to the bridge/gatekeeper 106 (upstream channel). Optionally, audio may also be generated and transmitted, but may not be necessary. Similarly, the other player associated remote terminals 112(2 thru N) generate and transmit similar video/audio, as shown.

The dealer terminal 114 generates and transmits video/audio of the dealer viewing/playing area 321, and any object(s) placed with this area, and optionally additional activity information, to the bridge/gatekeeper 106 (upstream channel). The dealer terminal 114 receives video/audio signals (in one embodiment, composite signals) from the bridge/gatekeeper 106 (downstream channel). The composite signal includes (1) video/audio from the dealer terminal 116, and (2) video/audio from each of the player remote terminals 110(1 thru N).

The dealer terminal 116 generates and transmits video/audio of the dealer (or overall table/game/activity view), and optionally additional activity information, to the bridge/gatekeeper 106 (upstream channel). The dealer terminal 116 receives video/audio signals (in one embodiment, composite signals) from the bridge/gatekeeper 106 (downstream channel). The composite signal includes (1) video/audio from each of the player associated local terminals 112(1 thru N),and (2) video/audio from the dealer terminal 114.

One or more video/audio signals may be transmitted from the bridge/gatekeeper 106 to the server 120, as shown and described previously. Additionally, data and other signals are typically transmitted to and received from the bank 130 and the server 140 via the network. As will be appreciated, the bridge/gatekeeper 106 may simply describe functionality provided by one or more devices coupled to the network 102.

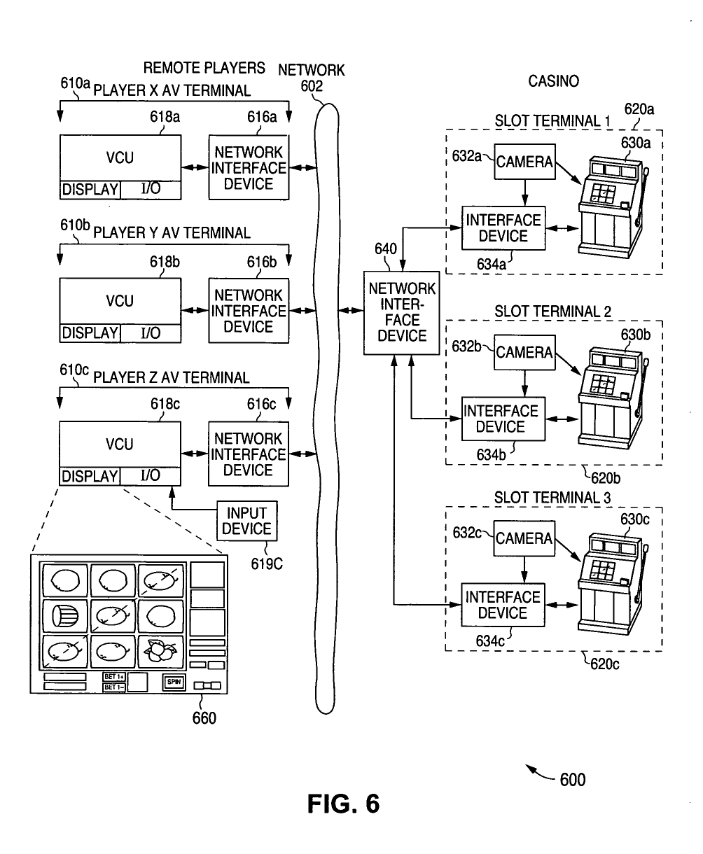

Now referring to FIG. 6, there is illustrated a slot machine gaming system 600 in accordance with the present invention. One or more remote player terminals 610a, 610b, 610c are communicatively connected via a network 602 to one or more local slot terminals 620a, 620b, 620c. As illustrated, the remote players (remote gambling terminals) are shown on the left side of the network 602 while the slot terminals 620 are shown on the right side of the network 602. The components shown on the left side may be characterized as the “player component” of the slot gaming activity. As will be appreciated, the player remote terminals 610 may be located anywhere, and are generally geographically separate from the slot terminals 620. The components shown on the right side may be characterized as the “casino” component of the slot gaming activity. The slot terminals are located within one or more facilities (i.e. casino) and may include multiple casino locations.

Similar to the player terminals 110, each of the player remote terminals 610a 610b, 610c includes a network interface device unit 616 and a videoconferencing unit (VCU) 618, wherein the VCU 618 further includes a display and input device (and optionally additional I/O devices or I/O connections). Though not necessary, each of the player remote terminals 610 may optionally include a video camera for capturing an image of the player or other object present at the location of the player remote terminals 610, if desired, for transmission to the casino side.

Referring now to VCU 618c of the player remote terminal 610c, the terminal 610c includes an input device 619c, such as a keyboard, mouse, softkeys or other means for providing input to the VCU 618c. The input device 619c may be integrated with or external to the VCU 618c. FIG. 6 includes an example image 660 of a slot machine image that may be displayed on a display unit of the VCU 618c. The display unit may be integrated with or external to the VCU 618.

Each slot terminal 620 is communicatively coupled to the network 602 via a network interface device 640 providing switching/routing and network interfacing functions. In another embodiment (not shown), the slot terminals 620 may include an internal or separate network interface unit for direct connection to the network 602, without the need for the interface unit 640.

The slot terminal 620 includes a stand-alone slot machine 630, an interface device 634, and an optional video camera 632 (which may include audio input functionality). The stand-alone slot machine 630 may be of the type that operates with mechanical reels (thus providing a visual display of the reels to the user) or electronic reels (thus internally generating an image of the reels and providing an electronic display output image of the reels to the user).

It will be understood that the terminal 620 may include a terminal processor or controller (not shown) that functions similarly to the game/table processor 312 (shown in FIG. 3) and such functionality may be located in the interface device 634, in the slot machine 630, or in any other communicatively coupled location.

When operating with “mechanical” stand-alone slot machine that utilizes mechanical reels and a front display (e.g., lights, pot, bet, winnings, etc.) are visually available to a user (i.e., typically when a user is standing in front of the slot machine), the video camera 632 may be used to capture the real-time image of the reels and front display images (e.g., the standard front display of the slot machine). When operating with an “electronic” stand-alone slot machine that utilizes “electronic” reels internally and outputs an electronic display to the user, the video camera 632 may not be necessary, and the reel image (and any front panel images) generated and available internally may be duplicated or diverted (with or without additional processing) and output to the interface device 634.

It will be understood that the slot machines 630 are stand-alone slot machines. As such, all the functionality and components necessary to operate the machine are included or housed within a single unit or frame. Further, the interface devices 634 may be videoconferencing control units, with or without an integrated camera, display or I/O devices.

As will be appreciated, the remote player operably receives real-time (or live) video/audio from the slot machine and participates contemporaneously, and provides input or interaction that is live or real-time (video or audio) from the remote player.

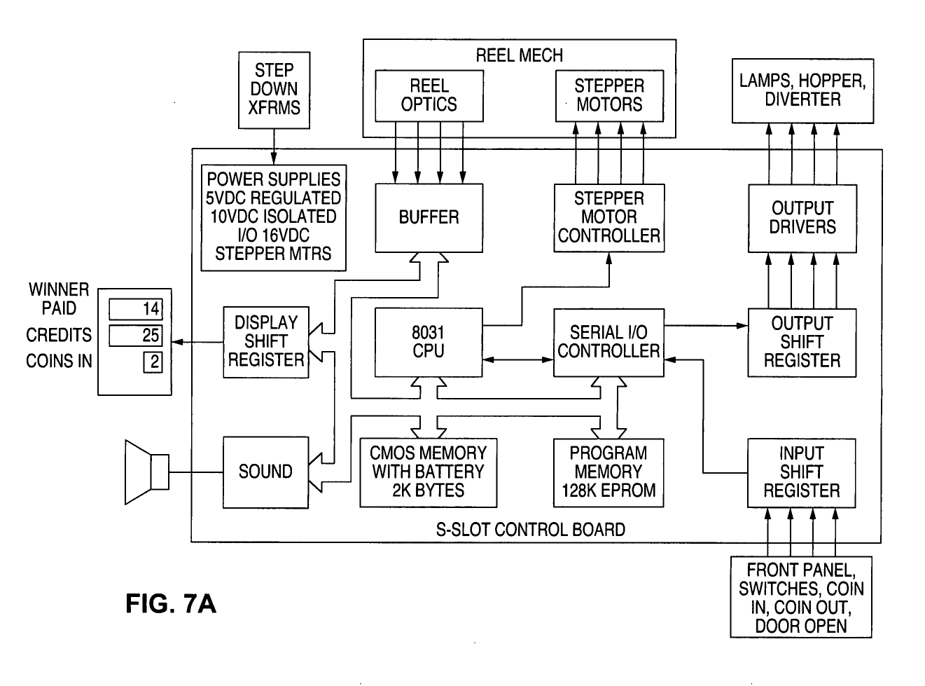

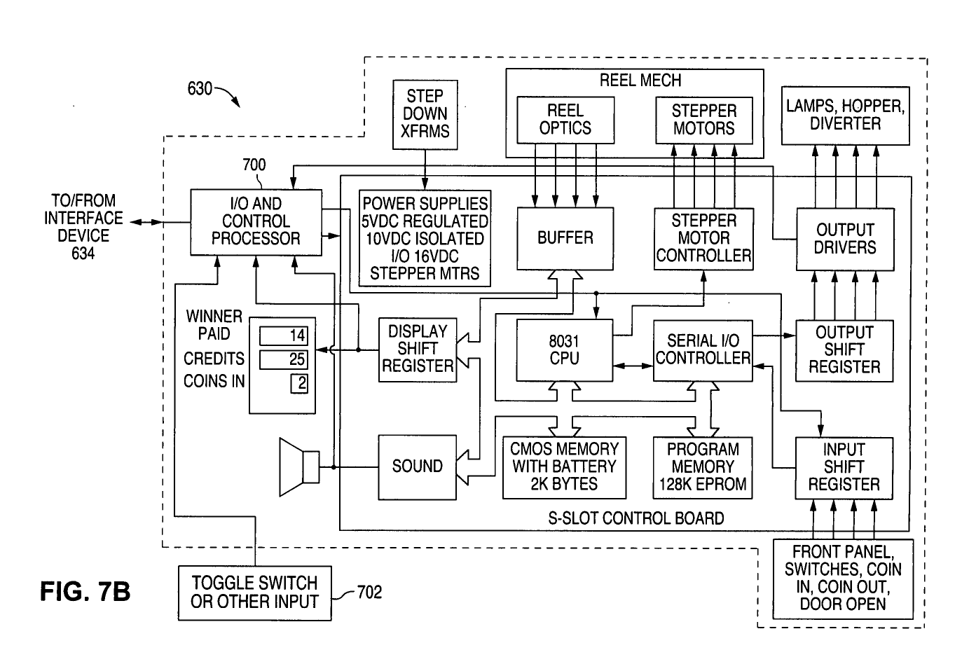

Now referring to FIG. 7A, there is illustrated a basic block diagram of a prior art stand-alone slot machine. The components and operation will not be described herein as this is readily understood by those skilled in the art.

Now referring to FIG. 7B, the there is illustrated a basic block diagram of the stand-alone slot machine 630 (shown with dotted lines) in accordance with the present invention. Components and functionality similar to prior art components and functionality will not be described herein. The slot machine 630 includes an input/output and control device or processor 700 that receives and transmits communications from the interface device unit 634 (or directly with the network interface device 640). The I/O and control device 700 (that may be the same as, or similar to, the terminal processor described above) is operable for receiving control signals (requested actions) via the network 602 from the remote user (i.e., from a player remote terminal 610). Received control or command signals provide operational control of the slot machine 630, including operations such as amount of bet, cash out, slot pull/roll, etc.). The I/O and control device 700 may also transmit control signals to one or more devices within the network 102, including the connected player remote terminal 610 and/or the terminal processor or electronic transaction server (not shown). For example, depending on the result of the play, or other requested action by the user, transaction messages or signals may be transmitted to credit/debit a specific account.

If utilized in an electronic stand-alone slot machine, the I/O and control processor 700 also functions to manage, control and generate internally audio and video representing images of the reel and front panel. If utilized in a mechanical stand-alone slot machine, such functionality may not be necessary as video image of the front portion (e.g., reel and front display) of the slot machine may be captured by a video camera monitoring this playing/viewing area. In both embodiments, the I/O processor and control device 700 may generate additional video/images such as video overlays, image add-ons, or user buttons for providing additional game information (e.g., current bet, current credits, game rules, payouts, etc.) and button links within the video for display to the remote user thus allowing display cursor input (e.g., point and click) for betting, play and other control. The I/O and control device 700 is shown integrated with the stand-alone slot machine, but could also be a separate device or the functionality could be included within and interface device.

The slot machine 630 may optionally include a toggle switch or other control input 702 for enabling/disabling different modes of operations—on-line remote play or traditional play (dual modes). In the on-line mode, the slot machine 630 would not accept traditional control or play, but would accept remote control and play, while in the traditional mode, would allow only traditional play and disable inputs/outputs from the slot machine 630 to any network interfacing unit. In another embodiment, the slot machine 630 may be configured for a combination mode, if desired, thus allowing a first come, first served game (whether traditional or remote on-line).

The basic operation of one individual slot session (or game) of the slot gaming system will now be described. A player remote terminal 610 (user) communicatively connects to an available slot terminal 620 via the network 602. Once connected, the slot terminal 620 transmits video of the slot machine 630 to the player terminal 610, which displays the video to the player. Based at least partly upon the images displayed, the player interacts and controls operation of the slot machine 630 through input to the player remote terminal 610 which is transmitted to the slot terminal 620 via the network 602. The slot terminal 620 receives (and translates) this input into control signals that control operation of the slot machine 630. For example, the player inputs a bet amount, the bet is authorized, the player inputs “pulls” the slot arm, and the game is concluded. During this time, the player sees a live video image of the connected slot machine (i.e., the same view as if he/she was physically present in front of the slot machine). Thereafter, the player plays the slot machine as many times as desired, until the player terminates the session, such as by “cashing out.”

The slot machine 630 (or slot terminal 620) are stand-alone units that are physically and communicatively separate from the other slots. In other words, the slot machines are actual units and are not simply a process or program within a software program executing on a computing system (i.e., a slot machine software program running within a computing platform).

The system will optionally incorporate a timeout period or slow play detection functionality that will cause an automatic termination of the session when there is no activity or a warning to the player of slow game play and that if continued, the session might terminate automatically. As such, the session communications may be monitored, as well as the slot machine play.

It is contemplated in the present invention that each device within a network be independently addressable via a communication address. Such communications addresses may be configured using any of the various addressing schemes, though specific embodiments may utilize any dialing plan (e.g., North American or worldwide dialing plan), domain name service (DNS), or addressability via Internet (IP). It is also contemplated that some of the network devices shown herein (e.g., player remote terminals, player associated local terminals, dealer terminals, slot terminals, and other devices), may utilize sub-addressing within a local-type network.

As one example, a casino may utilize a single communication address visible to the network as the initial communication address for a plurality of slot machine terminals. In such case, the casino network device (such as a router, switch, hub or other modem device) coupled to the network would provide internal addressing for each slot machine terminal and transparent to the remote user. Similarly, a plurality of player remote terminals may be located at a single location and connected to the network through a single address point (such as a router, switch, etc.). Other addressing and access methods are contemplated and within the scope of the present invention.

For example, a player remote terminal 610 may request connection (via the network 602) to a main server or network device (not shown) having an advertised (known to the player) destination communication address. The main server may respond with a web page or video screen that shows all available casinos and their communications addresses. Sub-menus may be provided for each casino showing types (which may or may not provide a communications address for these types) of different categories of activities/games (e.g., blackjack, poker, slots, keno, roulette, craps, etc.) with further sub-menus showing actual game tables or slot machines (with a communications address for each table or slot machine) available for play, which may further be delineated into seats at a particular game table. Such features will also allow the remote player to select the particular device (e.g, seat or slot machine) to connect with. An exemplary hierarchy is illustrated in FIG. 8. As will be appreciated, different entry points may be used by the remote player. Such information may be advertised via webpages or other available network devices via the broadband network (e.g, webpages) with hyperlinks to the sub-categories and to specific seats and slot machines. This would allow a remote player to navigate through a casino (or multiple casinos) and view the available activities in order to begin playing at a table or slot machine. A connection to a table, table seat or slot machine would be done by selecting the desired link (communication address) and the player remote device would initiate connection to the device.

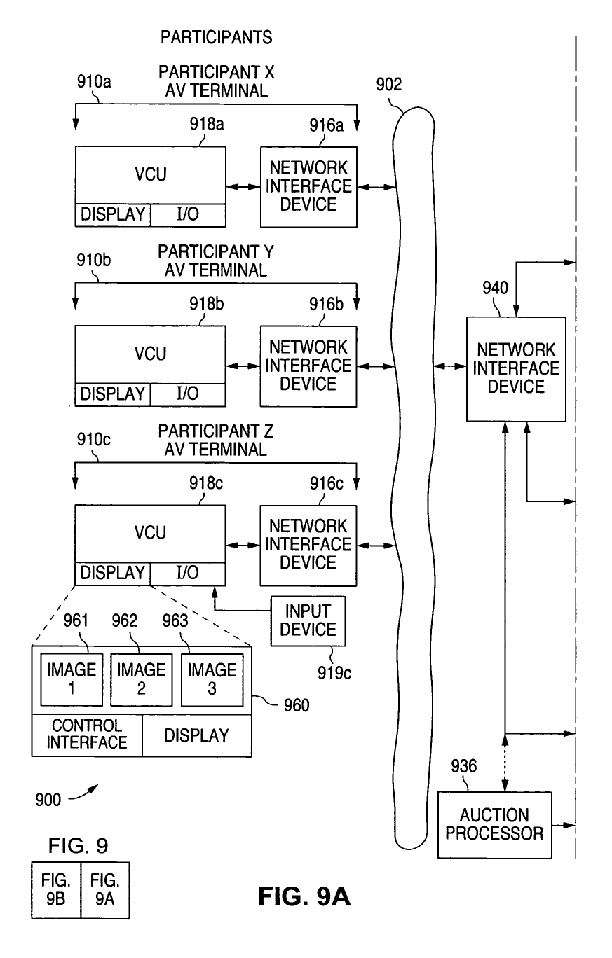

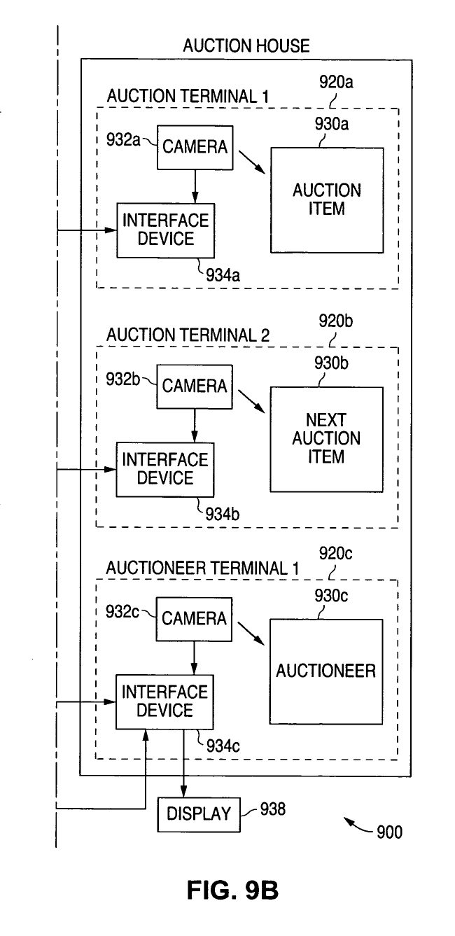

Now referring to FIG. 9, there is illustrated a live on-line auction gaming system 900 in accordance with the present invention. One or more remote participant terminals 910a, 910b, 910c are communicatively connected via a network 902 to one or more auction terminals 920a, 920b, 920c. As illustrated, the remote participants (remote auction terminals) are shown on the left side of the network 902 while the auction terminals 920 are shown on the right side of the network 902. The components shown on the left side may be characterized as the “participant component” of the live on-line auction activity. As will be appreciated, the participant terminals 910 may be located anywhere, and are generally geographically separate from the auction terminals 920. The components shown on the right side may be characterized as the “auction house” component of the auction activity. The auction terminals are located within one or more facilities (i.e. auction house) and may include multiple auction locations (such as the auctioneer could be located in one facility while the items to be auctioned are located in a different facility or facilities).

Similar to the player terminals 110, 610 each of the participant remote terminals 910a, 910b, 910c includes a network device unit 916 and a videoconferencing unit (VCU) 918, wherein the VCU 918 further includes a display and input device (and optionally additional I/O devices or I/O connections). Though not necessary, each of the participant remote terminals 910 may optionally include a video camera for capturing an image of the participant or other object present at the location of the participant remote terminals 910, if desired, for transmission to the auction side.

Referring now to VCU 918c of the participant remote terminal 910c, the terminal 910c includes an input device 919c, such as a keyboard, mouse, softkeys or other means for providing input to the VCU 918c. The input device 919c may be integrated with or external to the VCU 918c. FIG. 9 includes an example image 960 an auction image that may be displayed on a display unit of the VCU 918c. The display unit may be integrated with or external to the VCU 918. In one embodiment, the image 960 includes a first image 961, a second image 962 and a third image 963. Each of the images is generated by and received from the auction components. In a specific example, the image 961 may be the image of the item currently being auctioned, the image 962 may be the next item up for auction, and the image 963 may be the image of the auctioneer or overall auction house. A portion of the screen may display interface/control information to allow the user to bid for the current auction item and provide auction information (such as current bid, item information, etc.).

Each auction terminal 920 is communicatively coupled to the network 902 via a network interface device 940 providing switching/routing and network interfacing functions. In another embodiment (not shown), the auction terminals 920 may include an internal or separate network interface unit for direct connection to the network 902, without the need for the unit 940.

The auction terminals 920a, 920b include an interface device 934, and a video camera 932 (which may include audio input functionality). The video camera 932a captures the image 930a of the actual physical object (item currently under auction) placed within the viewing area of the camera 932a. The video camera 932b captures the image 930b of the actual physical object (e.g., next item to be auctioned) placed within the viewing area of the camera 932b.

Similarly the auctioneer terminal 920c includes an interface device 934c, and a video camera 932c (which may include audio input functionality). The video camera 932c captures the image 930c of the auctioneer or overall view of the auction house or area (within the auction house facility) within the viewing area of the camera 932c. Further, the interface devices 934 may be videoconferencing control units, with or without an integrated camera, display or I/O devices. An additional display 938 may be provided to

An auction processor device 936 is provided that controls various aspects of the auction. The device 936 may be a component within the auctioneer terminal 920c, or a stand-alone device coupled to the network, or its functionality could be provided within any other device in the system, and will further include input/output capabilities (not shown) to allow the auctioneer (or related person) to enter data, control signals, etc. Such device 936 may include similar functionality to the processor 312 in the system shown in FIG. 3.

Similar to the system in FIG. 1, the auction system 900 may include a bridge/gatekeeper (not shown) that similarly functions to receive video/audio from one or more of the terminals 910, 920 and combine one or more signals into a composite signal for transmission to any of the terminals. For example, the composite image 960 may be generated by combining the three separate video/audio signals received from the respective auction terminals 920a, 920b, 920c. As will be appreciated, this composite signal is transmitted to each of the participant terminals 910 for viewing by the participant.

A similar device addressing scheme may be utilized for the auction system 900 as described with respect to the slot gaming system 600.

The basic operation of an auction of one item in the auction system will now be described. A participant remote terminal 910 (user) communicatively connects (via the network 902) to one of the network devices within the auction component. Once connected, the auction terminals 920 transmit video/audio from each terminal 920 to the bridge/gatekeeper (not shown) within the network 902, which combines the video/audio into a composite vide0/audio signal transmitted to the participant terminal 910, which displays the video to the participant. Based at least partly upon the images (and perhaps audio) displayed, the participant interacts becomes involved in the auction process. The participant may bid through I/O of its respective associated participant player terminal 910 (e.g., audio, mouse, keyboard, softkeys, etc.). As such, bidding information is individually received from the connected participants, either via audio or electronically, and input to the auction processor 936. The auction processor 936 processes this information and updates the bidding history and provides the current bidding history (and any other desired auction information) using video overlay or composite video imaging processing, onto the video stream from the auctioneer terminal 920c (transmitted to the bridge/gatekeeper.

Optionally, the auction house can generate a single video/audio stream locally of each of the video/audio signals of the auction terminals 920, and provide a single video/audio stream to each of the participant remote terminals 910 without the need for video composite imaging within the bridge/gatekeeper. In this case, the auction system can be described as a one-to-many system.

As will be appreciated, the remote participant operably receives real-time (or live) video/audio from the live auction and participates contemporaneously, and provides input or interaction that is live or real-time (video or audio) from the remote participant.

In another embodiment (not shown), a plurality of cameras are provided at the auction site and each participant receives video/audio exclusively from one of the terminals associate with that participant (i.e., connected). In this way, a participant may have exclusive control over the camera and its movement, and may remotely control the camera to allow different views.

In other embodiments, upon connection to the gaming or activity, user interface software or interface information may be downloaded to the player/participant remote terminals 110, 610, 910. This may provide one or more graphical user interfaces that appear on the user's display for guiding/receiving user input and providing such functionality. Additionally, this information may include programming for softkeys or other user input interfaces for I/O either integrated with or externally-connected to the remote terminals or VCUs (network device).

As will be appreciated, the player remote terminals 610 (and thus, the players) may be located anywhere.

In other embodiments, one or more recording devices (not shown) may be included within the network or system. Such recording device(s) may be coupled within the network at any locations and/or to the player remote terminals, player local terminals, dealer terminals, and/or bride/gatekeeper to record selected video/audio signals (in any format). The recording device(s) are operable for recording data, video/audio on any recordable media (e.g., VHS or other tape, DVD, hard drive, etc.). These devices may be used to record identification items (driver's license, passport, images) associated with the remote players/participants, as well as various aspects of the game/activities (e.g., the displays of the dealer terminals 114, 116), for security, authorization and archival purposes.

In further embodiments, the video/audio transmissions (and control signals) may be encrypted/coded from endpoint to endpoint or between any devices in the network in accordance with any security or encryption protocols or methods. For example, secure communications between a specific player remote terminal and its player associated local terminal may be utilized to raise the level of privacy and security.

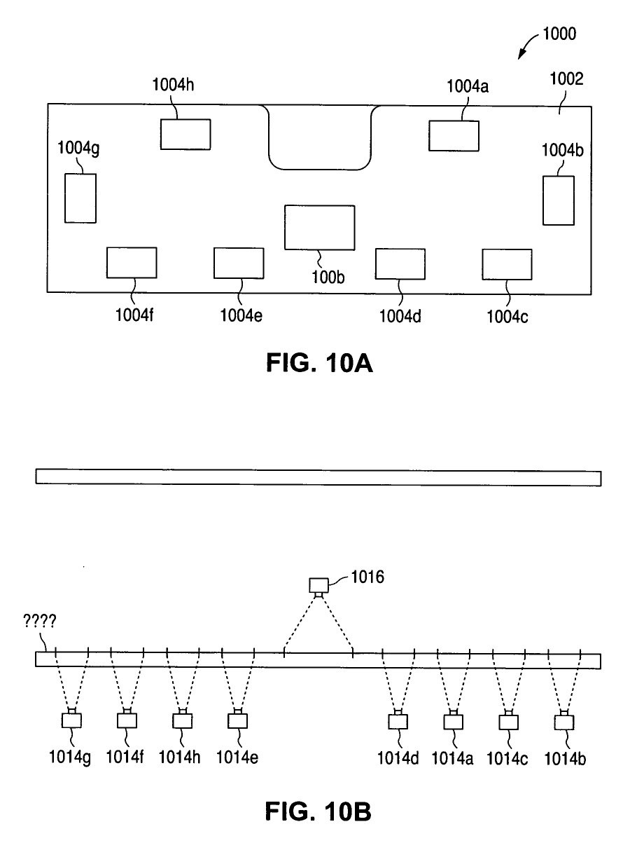

Now referring to FIGS. 10A and 10B, there is illustrated a top view (FIG. 10A) and side view (FIG. 10B) of a game or activity table or platform 1000 in accordance with the present invention. The table 1000 shown, is an exemplary table that may be used for an 8-player poker or blackjack game. The table 1000 may take on other configurations for use with any other game or activity. It will be understood that use of the term “table” is not limited to a traditional table, but refers to any platform or object(s) in any form or shape of construction that provides the functionality described herein.

The table 1000 includes one or more surfaces 1002 having a plurality of predefined player viewing/playing areas 1004a thru 1004h, as shown. The table 100 also includes a predefined dealer viewing/playing area 1006. Each of the viewing/playing areas 1004a-h, 1006 are monitored by a respective video camera 1014a-h, 1016. The cameras 1014a-h, 1016 capture video images of any object(s) placed within the viewing/playing areas 1004a-h, 1006 and transmit the video (and optionally audio) signals to a video processor or network device for further processing or transmission (as described above). By way of example, the video cameras 1014a-1014h, 1016 may be those cameras (306(1-N), 346) as shown in FIG. 3. Another video camera (not shown) may be appropriately placed to capture images of the dealer or the overall table (view). By way of example, this camera may be the camera 356 shown in FIG. 3. As will be appreciated, the video cameras may include audio input devices, as well, to capture the audio received at the specific location.

With reference to FIG. 10B, the cameras 1014a-h are shown positioned below the table 1000, while the camera 1016 is shown positioned above the table 1000. In this configuration, the surfaces of the viewing/playing areas 1004a-h may include a transparent material, such as glass, to allow the camera to monitor the areas. As will be appreciated, the positioning and configuration of the cameras 1014a-h, 1016 (and the dealer image camera) may be chosen as desired, depending on several factors, including security, the place and type of game played, etc. All cameras may be positioned above the table or below the table, or some above and some below. Moreover, the table 100 and cameras may also be oriented in any position or manner, as desired.

Using a blackjack game as a specific example, a dealer would deal the hand by retrieving the playing cards from a traditional deck of playing cards (as normally utilized in a conventional blackjack casino game) and placing each player's cards and the dealer's cards in their respective viewing/playing area 1004a-1004h, 2006—with each card either faceup or facedown in accordance with the game—so that the remote player can have the proper views of his/her hand and the dealer's hand. Once dealt, each remote player receives real-time or live video of that respective player's viewing/playing area and the dealer's viewing/playing area. As such, the game proceeds in the traditional fashion, with the exception that the players are physically remote from the table 1000. The remote players utilize telecommunications network to receive and view an image of their actual dealt cards, and to further provide input to the table (or dealer) as to betting further activities of the game.

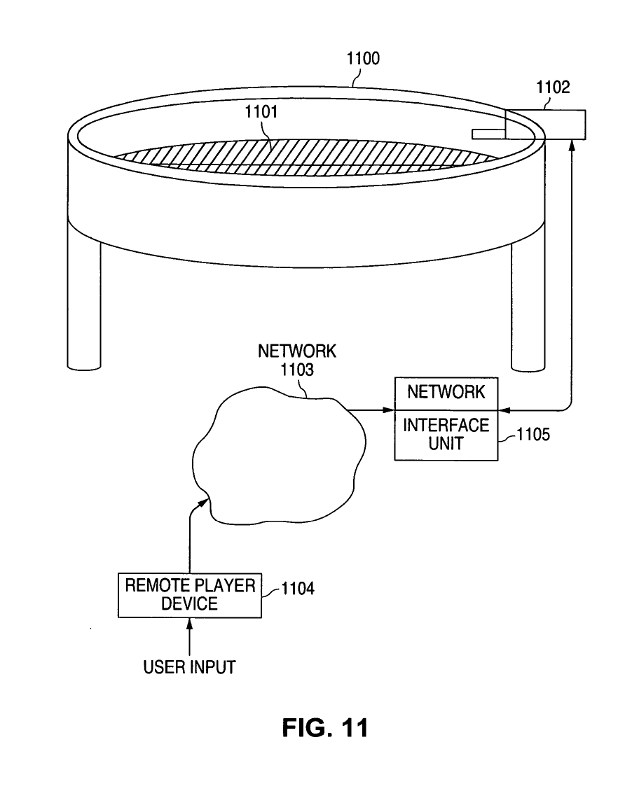

Now referring to FIG. 11, there is illustrated a game or activity table or platform 1100 used in conjunction with a game/activity involving the rolling/tossing of one or more die (one or more die or dice, and hereinafter die or dice). The table 1100 has a surface 1101 for receiving rolled/tossed die. The table 1100 also includes a die rolling/tossing device 1102. The die rolling/throwing device 1102 ejects (or rolls/tosses) die onto the surface 1101 in accordance with the game played. The device 1102 receives (or is loaded with) dice and ejects the dice in response to commands or input (user input) received from a remote player device 1104 via a network 1103. Such command/input is in the form of electronic signal(s) or message received via the network 1103. A network interface unit 1105 receives the control signal over the communications network processes the signal and transmits a signal to the die rolling/throwing device 1102.

It will be understood that the network 1103 and remote player device 1104 may be, for example, similar or the same as the player/participant remote terminals 110, 610, 910 and the network 102, 602, 902, respectively, as described herein.

The player remote device 1104 (of the player whose turn it is to roll) controls the rolling/tossing of the dice. The ejection of dice from the device 1102 is controlled electronically via the network 1104. The level of control may range from simple (trigger to throw) to complicated (such as that capable in some video games user input controls). This may be accomplished by a joystick controller or other input means (not shown) at the remote player device 1104, and may further be as simple as pressing a button. The time period the button is pressed may also be included in the control signal, along with other input means and methods, to provide the user the ability to control some aspect (such as amount of energy for ejection, direction of roll/toss, etc.). Other button(s) or control device(s) (input means) at the player remote device 1104 may be utilized.

In one embodiment, the device 1102 uses an electro-mechanical motive means to eject the die (or dispense onto the surface 1101). The term “electromechanical” is used broadly, and refers to receiving an electrical control input signal that causes a mechanical action. Other motive means may be used. In operation, at the appropriate time, a dealer will place the die in a die-receiving means (not shown, such as a tube or platform or other device for receiving and supporting the dice), and the device 1102 will be enabled to receive user input from the player remote device 1104. Upon receipt of the control signal, the dice will be forcibly ejected by a mechanical firing pin or arm (mechanical) or the discharge of air (pneumatic). Other means or methods of ejection may be used.

The table 1100 shown is not limited to a “table” or a craps table, but may be any platform or device operable with a game that include the rolling/tossing of one or more die that includes an electro-mechanical device for rolling/tossing the die in response to an electronic control input from a remote person (remote from the table activity, and thus unable to physically roll/toss the die). As will be appreciated, the device 1102 may be integral with the table, mounted thereon, or stand-alone, and positioned appropriately.

The present invention contemplates that one or more of the remote players, casinos and auction houses will utilize an intermediate financial transaction setup and clearing account, such as PayPal®, or another system functioning similar thereto under the name Betting Buddy™ (or Bidding Buddy™). A player (or casino/auction house) establishes a new account on-line via connection to a designated banking institution to provide such service. The player creates an account by selecting a user id (screen name) and password (passcode). Once established, the account may be viewed and managed by the account owner. Deposits/withdrawals are made using the credit/debit card numbers or other traditional methods. In this embodiment, account owners are unable to access credit/debit card/financial information of the other party in the transaction.

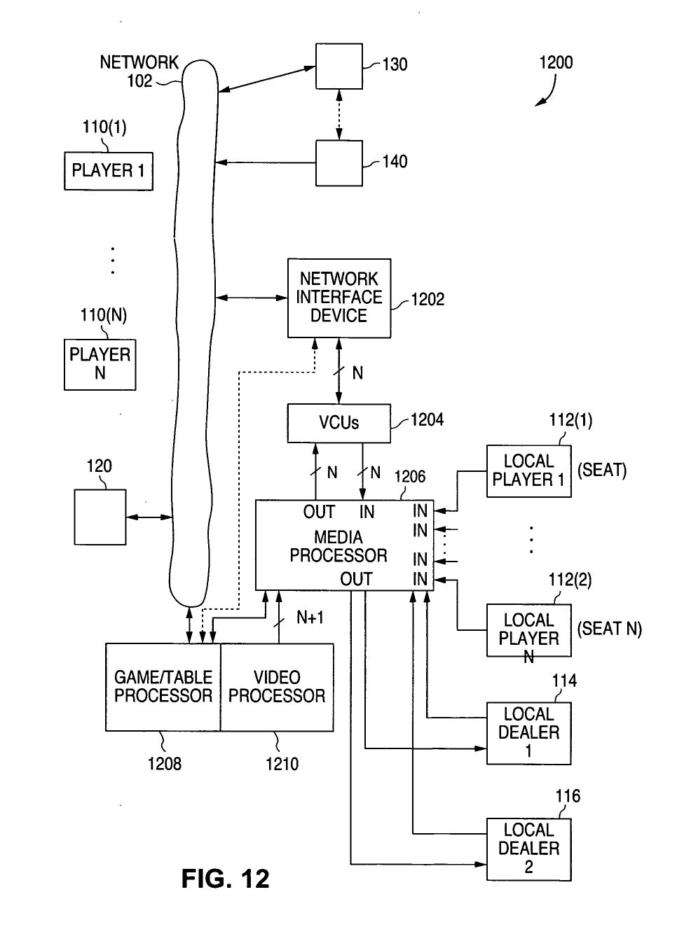

Now referring to FIG. 12, there is illustrated another embodiment of a gaming system 1200, similar to the system described with respect to FIGS. 1-4, in accordance with the present invention. Like reference numbers refer to like components in previous figures.

The system 1200 includes a network interface unit 1202 for connecting to the network 102. The network interface unit 1202 may be a router, switch, hub or combination of these, that provides bandwidth sufficient to handle a plurality of physical or virtual channels for connection to the network 102 (such as a T1 or T2 line). In another embodiment, the unit 1202 includes N separate interface units, one for each local player terminal 112, and each with a physical connection to the network 102.

The network interface unit 1202 receives and transmits a plurality of channels and routes each channel over one or more physical lines to one or more VCUs 1204 (multiple stand-alone units or an integrated unit may be utilized). In the embodiment shown, a number N of channels (with upstream and downstream channels) carry data (in the form of packets) between the VCU 1204 and the interface unit 1202 via a LAN or multiple lines. Each channel carries video/audio data (and optionally some control data). The network interface unit 1202 also communicates with a game/table processor 1208.

The VCU 1204 is communicatively coupled to a media processor 1206 having numerous input/output connections for video and audio signals. The media processor 1206 functions to receive a plurality of video and audio signals and generate various combinations and overlays (inlays) of video and audio signals, as desired. The composite video and audio signals are output to various devices. An exemplary processor 1206 is a media processor available from 9× Media, Inc.

The game/table processor 1208 may also be directly coupled to the network 102 and/or connected via the network interface device 1202. The processor includes functionality similar to the game/table processor 316 shown in FIG. 3 and controls various aspects of the game/activity in response to input and other input devices (not shown, such as a dealer input device).

In general operation, the media processor receives several inputs. These include (1) player video and audio (from each player remote terminal 110) received by the VCU 1204 (which has converted from the data from packets to standard or analog video and audio (such as NTSC, PAL)) and output to the media processor 1206, (2) video (and optionally audio) from each of the player local terminals 110, (3) video and audio from the each of the dealer terminals 114, 116, and (4) a plurality of overlay video signals (N+) from a video processor 1210 coupled to the game/table processor 1208, as shown. The media processor 1206 generates several outputs. These include the ten composite video and audio signals as described above with respect to FIGS. 3 and 4. In another embodiment, the video overlay images to be combined with the video from the player local terminals 112 and dealer terminal(s) 114, 116 may be combined with such video signals outside the media processor by another device or method, and then input as the respective (image overlays already combined) video signals.

The N player composite video/audio signals are transmitted to the VCU 1204 which converts them into the proper format for ultimate transmission over the network 102 to each of the respective remote player terminals 110.

The game/table processor 1208 generates instructions or data and transmits to the video processor 1210 which generates overlay images to be placed upon the respective images of the players' viewing/playing areas.

As will be appreciated, the system 1200 may include any other operations, capabilities and functionality as described with respect to any of the various embodiments described herein.

The following provides one embodiment of a general flow describing a remote player joining and playing/participating in a real-time live game or activity occurring (or which will occur) at a location remote from the player. The following description is directed to a casino game, but the method is also applicable to other real-time or live on-line activities.

The remote player enters a main gaming number (independently addressable communication address) associated with a gaming server 140 coupled the network (e.g., an entry point such as a main casino server 140) resulting in the transmission of a connection request thereto. Upon connection, the server 140 and remote player engage in traditional logon steps. The server 140 may then connect, or direct the remote player, to the bank or account server 130 to access a gaming account (previously set up and similar to a conventional online bank or financial institution account). The gaming account is setup and linked to another transaction account, referred to as a betting account which is similar in nature to a PayPal or Betting Buddy account (as previously described). The gaming account is typically funded with a credit/debit card or another traditional way.

The remote player provides instructions transferring a predetermined amount from the gaming account his betting account. This is similar in nature to the conventional method of a gambler buying “chips” from the casino. Once the betting account is funded, the server 140 provides gaming choices to the remote player. These choices may include a listing of all games, tables and/or and seats hosted by a given entity or entities, or only those positions that are available to be selected (i.e., seats/positions at a table/slot not taken). These listings may further be in the form of hyperlinks or include buttons that would allow the remote player to click and connect, or may simply include phone numbers for calling to connect. Other configurations are possible.

In one embodiment, the listing includes all resources available, such as an identification of all games/table/slots, etc., and whether the resource is currently available, unavailable (open for use), table closed or other status information. In addition, the listings may include multiple links, such as a “view” and “connect” link, giving the remote player the option to view the game/table/slot to see who what the game/table/slot looks like and/or identify who is playing (by receiving the video of the game/table/slot and/or of the players and the dealer/dealer hand) or connect and begin playing.

The remote player begins play by connecting to the desired terminal. This may be accomplished upon selection and connection to a game/table/slot. Optionally, the remote player may also select a particular seat of a game/table, or the casino will assign an available seat to the remote player. Upon selecting (connection request) a seat/slot, connection configurations are established and controlled by the bridge/gatekeeper 106 (or the associated game/table processor) allowing the remote player to transmit and receive the appropriate video/audio signals. Betting account information is also transmitted to the game/table processor associated with the game/table/slot.

Once connected, the remote player begins play, and betting occurs by the players, etc. for the game. The specifics of the play and how the system operates has been previously described. At the end of a hand (for a card game) or play for a slot machine, the appropriate betting accounts (of the players and the casino) are debited/credited. When the remote player decides to quit playing altogether and logoff, the remote player has the option of keeping the amount in the betting account, or transferring the amount back to the gaming account.

It may be advantageous to set forth definitions of certain words and phrases that may be used within this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and if the term “controller” is utilized herein, it means any device, system or part thereof that controls at least one operation, such a device may be implemented in hardware, firmware or software, or some combination of at least two of the same. It should be noted that the functionality associated with any particular controller may be centralized or distributed, whether locally or remotely. The term “couple” or “connect” refers to any direct or indirect connection between two or more components, unless specifically noted that a direct coupling or direct connection is present.

Although the present invention and its advantages have been described in the foregoing detailed description and illustrated in the accompanying drawings, it will be understood by those skilled in the art that the invention is not limited to the embodiment(s) disclosed but is capable of numerous rearrangements, substitutions and modifications without departing from the spirit and scope of the invention as defined by the appended claims.

1. An interactive on-line gaming method, the method comprising:
generating a first real-time video signal of a first physical object in an on-going game occurring at a first location;
transmitting the first video signal to a first remote participant at a second location;
receiving input from the first remote participant, the input operable for interacting with the on-going game.

2. The method in accordance with claim 1 further comprising:
converting the generated real-time video signal from a first format to a second format, and wherein the transmitting transmits the converted real-time video signal to the remote participant at the second location.

3. The method in accordance with claim 1 further comprising:
generating a second real-time video signal of a second physical object in an on-going game occurring at the first location;
generating a third real-time video signal of a third physical object in an on-going game occurring at the first location;
transmitting the second video signal to a second remote participant at a third location;
transmitting the third video signal to the first remote participant and to the second remote participant; and
receiving input from the second remote participant, the input from the second remote participant operable for interacting with the on-going game.

4. An on-line interactive card gaming method, the method comprising:
dealing, at a first location, one or more playing cards associated to a first participant by placing the one or more cards within a first participant viewing area;
generating a first video signal comprising an image of the first participant viewing area thereby generating an image of the one or more playing cards placed therein;
transmitting the first video signal to a first remote participant at a second location;
dealing, at the first location, one or more playing cards associated to a second participant by placing the one or more cards within a second participant viewing area;
generating a second video signal comprising an image of the second participant viewing area thereby generating an image of the one or more playing cards placed therein;
transmitting the second video signal to a one of the first remote participant and a second remote participant at a second location; and
receiving, at the first location, input from the first remote participant, the input operable for affecting the on-going game.

5. A gaming system comprising,
a gaming table residing at a first location, the gaming table having a plurality of predefined areas on the table;
a plurality of cameras corresponding to the plurality of predefined areas, each of the plurality of cameras operable for viewing the respective predefined areas and generating a video signal comprising an image of an object placed within the predefined area;
means for transmitting the plurality of video signals generated by the plurality of cameras over a network to one or more players geographically remote from the first location; and
means for receiving input from the one or more remote players.

6.-8. (canceled)
